(19) United States
(12) Patent Application Publication
(10) Pub. No.: US 2021/0002959 A1
(43) Pub. Date: Jan. 7, 2021

(54) Fire Escape Device (Ladders with Safety Cord and Fall Arrest System)

(71) Applicant: Ashot Aroian, BOCA RATON, FL (US)

(72) Inventor: Ashot Aroian, BOCA RATON, FL (US)

(21) Appl. No.: 16/601,578

(22) Filed: Oct. 14, 2019

Related U.S. Application Data
(60) Provisional application No. 62/871,088, filed on Jul. 6, 2019.

(51) Int. Cl. E06C 1/56; A62B 35/00

(52) U.S. Cl. CPC E06C 1/56; A62B 35/0037

(57) ABSTRACT

Systems and methods are disclosed herein for a fire escape device in form of ladder that can pivotally be mounted to a support platform in form of a window opening or a balcony railing or fix to an interior wall with anchors and provides a safe escape route in case of fires primarily because of its safety cord system. The assembly allows users to fasten a safety belt/harness/full body harness around his body and attaches its lanyard to the top part of the safety cord with a pair of carabiners. Once secured user can start descending and due to the length of each safety cord being about two meters, user must reattach the harness/belt's lanyard to the next safety cord while descending.

This application claims the benefit of U.S. Provisional Application No. 62/871,088, filed on 6 Jul. 2019

### BACKGROUND

### Field of the Invention

Embodiments relate to a fire escape ladders for emergency exit through a window/balcony or from a roof. More particularly, the present invention relates to a fire escape ladder having improved ladder descent means that enhance safety during use.

### Description of the Related Art

Two- and three-story private homes generally do not have fire escapes from the upper floors and these are not required by the building codes and regulations. Since most of these homes are of wood frame construction, containing highly inflammable parts, the occupants are sometimes trapped on a upper floor and unable to escape. Former art that includes the use of ropes or ladders in emergency require experience and great physical prowess to negotiate an exit in this manner or allowing additional exit of infants, children or old folks. Climbing out of a window backwards on to a moving flexible ladder and carrying a child is extremely difficult and dangerous.

There are multiple inventions that have been proposed in prior art regarding ladders and their enhanced utility during such circumstances. For instance, an Escape ladder bearing U.S. Pat. No. 3,326,322A is issued to Jr Fred H Buck. The patent discusses a ladder, comprising a pair of stiles made of flexible material and arranged in spaced relationship to each other, and a plurality of rungs disposed one above the other between said stiles, each rung including an elongated substantially horizontally extending core and a sheathing surrounding said core and open at least at one end to permit insertion of said core, said sheathing having portions respectively extending laterally beyond said core at opposite ends thereof, said portions being folded upwardly and connected to said stiles adjacent said ends of said core, said stiles preventing movement of said core from said sheathing when said ladder is in operative position.

Another patent on Fire escape ladder and harness housed inside a container bearing a GB patent 2,359,108A is issued to Dennis Baker. The patent is about a ladder attached at a first end to a weight bearing axle housed in a container made from a metal alloy, which may be fitted to the outside of a window using bolts. Also attached to the weight bearing axle, via a rope is a harness. The ladder, comprising a rope and metal alloy rungs is attached at a second end to the inside of the container lid. In use, a catch on the container is released and the lid falls to the ground extending the ladder.

Another patent on Portable metal fire escape ladder bearing U.S. Pat. No. 2,979,154A is issued to Thomas A Bell. The patent is about a Chain type fire escape ladders have the unique feature of being capable of being collapsed into extremely compact units so that they may be conveniently stored inside a building until the use therefor becomes apparent. These ladders are useful in that they furnish convenient means for descending from a point some distance from the ground to the ground or a similar point of safety. The fire escape ladders of the kind with which this invention deals is usually constructed of chains of equal length with a number of predetermined spaced rungs. However, oftentimes when the collapsible ladder is not employed or not in use the ladder is gathered into a cumbersome bundle. At the upper end of many fire escape ladders known in the prior art, a suitable fastening or securing means is provided to prevent the ladder from falling out of the window. This fastening means may take the form of a clamp which is secured to the window sill. Or the clamp may fasten to a radiator which is oftentimes found beneath the window. It will be appreciated that people who find it necessary to employ the fire escape ladders for emergency use are usually at the time in a highly emotional condition. In such a state it will be seen that a person can only with considerable difficulty manipulate any sort of fastening device.

A Hidden fire escape bearing U.S. Pat. No. 7,004,287B1 is issued to James Barbara. The patent is about an improved safety ladder and safety window as well as a method for use are disclosed. The ladder is discrete and compact, for convenience. The ladder is stored in a hidden container that is an extension or an addition to a normal window, or made part of an existing window, for example by being housed in a box associated with the window. The inventive built-in safety ladder provides for an easy escape in the case of an emergency. The window may be employed in a double-hung window, casement window, awning, hopper, of any operating window which can be used for egress. The fire escape can be incorporated in wood, vinyl, aluminum, steel, and other types of windows. The box may also be used for housing other items such as emergency escape smoke hoods that are used as breathing apparatus, or as a hidden wall safe to store valuables and can be accessed using a security code.

A Foldable fire-escape ladder bearing French patent 1,990,005234A1 is issued to Göran ERIKSSON. The patent is about a ladder comprises at least two parallel arranged strings, which are interconnected by means of a plurality of pivotally arranged parallel rungs. The holes for the pivoting points of each rung are arranged in off-centered positions, which positioning increases the strength of the ladder in a surprising manner. Furthermore, the inner string comprises mounting means intended to co-operate with brackets which substantially facilitate the attachment of a ladder.

Another Fire escape ladder bearing U.S. Pat. No. 6,012,549A is issued to Jimmie Adams. The patent is about a fire escape ladder for attaching to a window for providing a means to escape a burning building. The fire escape ladder includes a pair of spaced apart arms adapted for engaging a generally vertically oriented wall such as a window sill. Each of the arms has a generally J-shaped upper portion adapted for hooking onto a sill, a main portion extending at an obtuse angle from the upper portion, and a spacing portion extending from the main portion and adapted for abutting an outer surface of a building. A stabilizer bar extends between the arms. A ladder portion extends from free ends of the main portions of the arms. The ladder portion has a pair of deformable lines and a plurality of rungs coupled to the lines at equally spaced intervals along a length of the lines.

Another patent on Portable fire escape ladder bearing U.S. Pat. No. 3,834,492A is issued to Scott Technologies Inc AMERICAN LA FRANCE Inc. The patent is about a portable fire escape ladder provides a window sill bracket with chains depending therefrom and a plurality of tubular rungs secured to the chains at spaced intervals there along.

A Fire escape ladder with integral air cushion bearing U.S. Pat. No. 5,203,427A is issued to Anthony E. Williams, Sr. Alonda O. Williams. The patent is about a portable fire escape ladder with an inflatable air cushion is provided. The ladder has an upper window sill engaging portion, and a plurality of frame members interconnected with rungs. The air bag is inflated by propellant from a trigger operable propellant source, for decelerating a person prior to alighting on the ground.

Another collapsible ladder suitable for use as fire escape bearing U.S. Pat. No. 3,946,833A is issued to Joseph F. Riehlmann. The patent is on a collapsible ladder suitable for installation on high-rise buildings and capable of modification to be architecturally unobstrusive and compatible with a variety of architectural designs is described. The ladder comprises two or more telescoping stile pair sections in which the upper stile section has an attached upper rung and the lower stile section has an attached lower rung. The intermediate rungs are slidably mounted in the telescoping stile members which are made of channel stock. In the normal position covering a window the telescoping stile pairs are retracted and the rungs are stacked one over the other adjacent to the attached upper rung. In an emergency the ladder can be released to the extended position for use from inside a window whereby it falls on pivot arms down and away from the building at a distance sufficient to permit passage of a person between the building and the ladder, the lower stile section extends, and the rungs fall into spaced position held by spacer arms between them. Release of one ladder actuates a release mechanism on the similarly mounted ladder on the floor below and so on, allowing an escape passage to a safe level or, if necessary, to the ground.

Another emergency fire escape means U.S. Pat. No. 3,692,145A is issued to Philip M Banner. The patent is about a fire escape device adapted to be mounted to an external wall of a building below a window. A platform is pivotally mounted on a wall. The chain or wire ladder is connected to the platform. When the platform is folded up, it provides an enclosure for the folded ladder. When the enclosure is opened, the platform falls pivotally to a horizontal position. The platform has a trap door in it, operating on hinges that also allow it to pivot downward and release the ladder inside. The ladder descends to the ground.

There are multiple inventions that have been proposed in prior art regarding ladder systems during any emergency. Although most of the inventions provide their utility in emergency situations because of their enhanced portability, foldable structures, added cushioning or other functional advancements.

However the current invention proposes a system where a new process of fire exit ladder system has been improvised. The system includes a ladder with a reliable and safe exit from 2d floors and up through a window or balcony in case of emergencies. The invention proposes a fall protection inform of a safety cord that is sewed to the ladder's side support which prevents users from falling. The user can wear the safety belt (or harness/full body harness) and attaching its lanyard to the safety cord and reattaching it while descending user will feel and act much more confident and even in case of a misstep user will not fall, but will keep hanging on the safety cord and then can continue descending.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### BRIEF SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a novel and improved fire escape means.

It is also the objective of the invention to provide an improved fire escape means for two-story and above private homes, industrial buildings and tenements.

It is moreover the objective of the invention to provide a dedicated ladder mounted in a window frame or a balcony railing which could be supplied as a single unit for easy incorporation into a building.

It is also the objective of the invention to provide a fire escape mean bearing a fall protection, safety cord that is sewed to the ladder's side support which prevents users from falling.

It is moreover the objective of the invention to provide a comfortable working ladder with harness or safety belt, which provides safety to its user even in emergency situation.

It is moreover the objective of the invention to provide a facility which is easily effective for all age groups.

It is also the objective of the invention to provide a system which can be very cost effective as compared to adding additional means of security with ladder.

It is further the objective of the invention to provide a dual and reliable facility for every user.

An even further object of the present invention is to provide an advance ladder with safety belt/harness/full body harness which is susceptible of a low cost of manufacture with regard to both materials and labor, and which accordingly is then susceptible of low prices of sale to the consuming public, thereby making such assembly economically available to the buying public.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a partial top view of the fire escape ladder with carabiners and two of safety cords attached, including hooks as an alternative attachment for window access.

FIG. 2 is a view of the safety belt with a lanyard and hooks.

FIG. 3 is a view of the safety harness with a lanyard and hooks.

FIG. 4 is a partial view of an embodiment of the fire escape ladder and the safety belt.

FIG. 5 is a manual for the fire escape device featuring a safety belt.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses a fire escape ladder with security belt/harness/full body harness to provide maximum protection to the user in emergency situation.

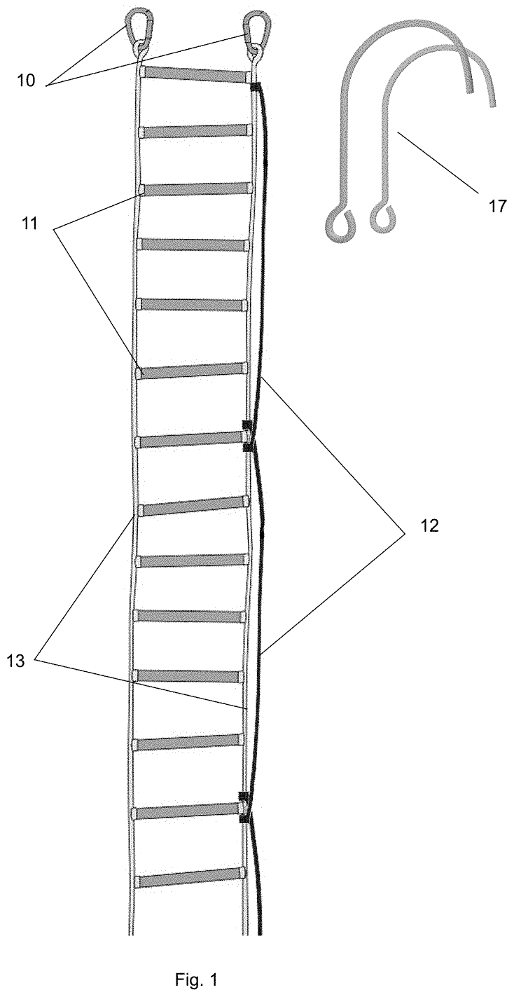

Referring to the FIG. 1, this invention provides a fire escape ladder comprising of two heavy duty safety carabiners (10) or hooks (17) for attaching to balcony railing or window frame respectively, a series of anti-slip rungs (11), attached to the flexible rope side supports (13) and a set of safety cords (12) sewed to one of the sides supports between the rungs. The length of each safety cord is about two meters. The fire escape ladder doesn't require any assembly. The safety hooks/carabiners allow for the ladder to be quickly attached to a window or a balcony railing in multiple ways.

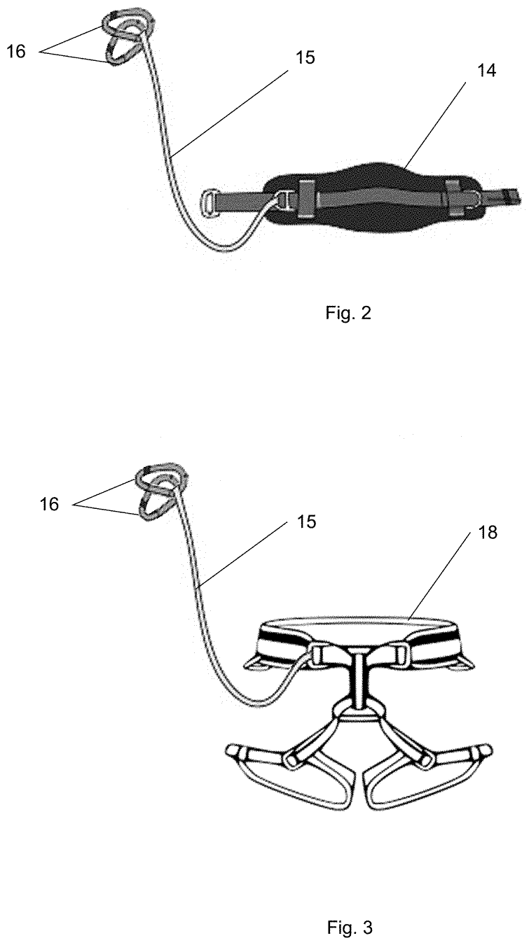

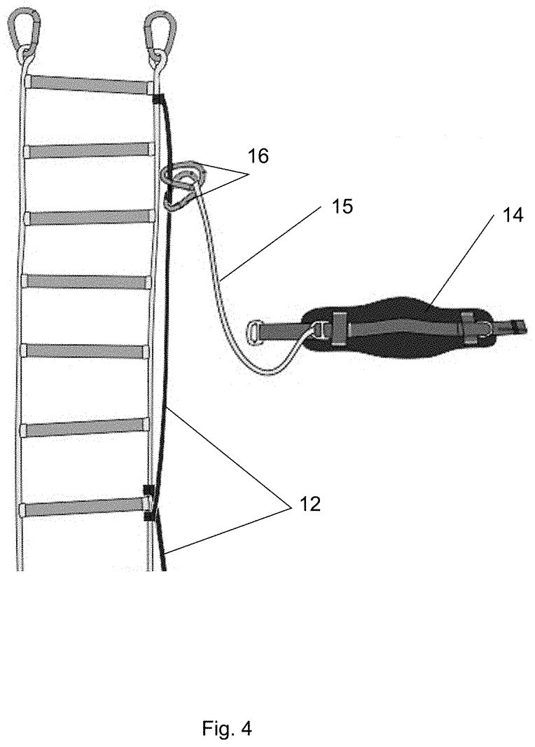

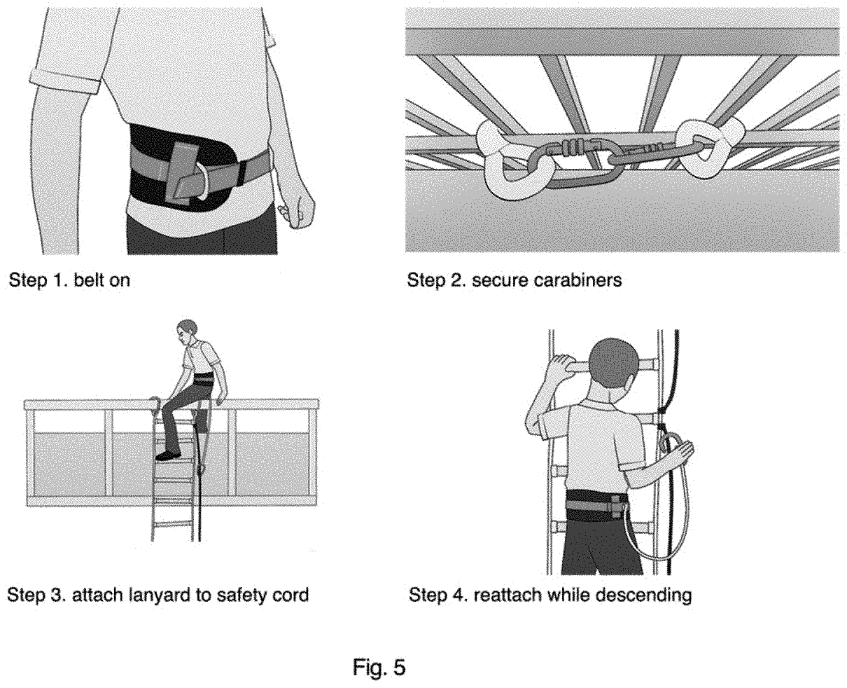

The ladder as per its additional embodiments is fully deployed when the hooks or carabiners are secured, and the ladder is lowered out of a window or a balcony to allow a safe descend. Referring to FIG. 2 the safety belt is comprised of a body (14), a lanyard (16) with a pair of safety carabiners on one end while another end is attached to the body. Referring to FIG. 3 featuring harness being comprised of a body (18), a lanyard (16) with a pair of safety carabiners on one end while another end is attached to the body. The pair of carabiners (16) is used for attaching the belt/harness to the ladder's safety cord (12) which is shown in FIG. 4 drawing, to allow user perform a secured descend.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing detailed description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separately claimed subject matter.

1. A Fire Escape Devise consisting of a main assembly in the form of
a ladder and further comprising of:
two flexible rope side supports;
two heavy duty safety carabiners or hooks at the top end of ladder;
series of anti-slip rungs attached to the flexible rope side support;
set of safety cords sewed to one of the sides supports between the rungs; and
a fall arrest system in form of safety belt/harness/full body harness comprised of:
the belt/harness' body;
lanyard attached to the body;
pair of carabiners for securing the lanyard to the ladder's safety cord.
